(19) United States
(12) Patent Application Publication
(10) Pub. No.: US 2026/0179983 A1
(43) Pub. Date: Jun. 25, 2026

(54) FUEL CELL SYSTEM AND METHOD FOR MONITORING A GAS TANK SYSTEM

(71) Applicant: Robert Bosch GmbH, Stuttgart (DE)

(72) Inventors: Birgit Lenz, Korntal (DE); Christian Kuhnert, Vaihingen/Enz (DE); Christian Schugger, Stuttgart (DE); Dorothee Sommer, Stuttgart (DE); Markus Strasser, Stuttgart (DE); Martin Schwab, Sindelfingen (DE); Nicolas Wussler, Esslingen Am Neckar (DE); Stefan Kieferle, Stuttgart (DE)

(21) Appl. No.: 19/127,233

(22) PCT Filed: Oct. 16, 2023
(86) PCT No.: PCT/EP2023/078662

§ 371 Date: May 5, 2025

(30) Foreign Application Priority Data
Nov. 7, 2022 (DE) 10 2022 211 717.4

(51) Int. Cl. H01M 8/04537; G01F 1/68; G01F 1/684; G01F 1/86; G05D 7/06; H01M 8/04082; H01M 8/04089; H01M 8/04746

(52) U.S. Cl. CPC H01M 8/04559; G01F 1/68; G01F 1/6847; G01F 1/86; G05D 7/0635; H01M 8/04089; H01M 8/04201; H01M 8/04753

(57) ABSTRACT

A method for monitoring a gas system comprises determining a fuel mass flow rate requirement of a consumer system (e.g., fuel cell system comprising a fuel cell assembly), closing a first valve device in order to interrupt a gas feed from a tank into a high-pressure pipe system connecting the tank to the consumer system, capturing a pressure curve in the high-pressure pipe system while the first valve device is closed, in particular by means of a pressure sensor, determining a theoretical actual mass flow rate in the high-pressure pipe system on the basis of the captured pressure curve, comparing the theoretical actual mass flow rate in the high-pressure pipe system with the determined fuel mass flow rate requirement of the consumer system, and generating an error signal by means of a control device if the theoretical actual mass flow rate deviates from the fuel mass flow rate requirement by more than a threshold value.

### BACKGROUND

The present invention relates to a fuel cell system, in particular for a vehicle, and a method for monitoring a gas tank system, which may be used, for example, in a fuel cell system.

Fuel cells are being increasingly used as energy converters, among other things in vehicles, in order to directly convert the chemical energy contained in a fuel, e.g., hydrogen together with oxygen, into electrical energy. Fuel cells comprises an anode, a cathode and an electrolytic membrane arranged between the anode and cathode. Oxidation of the fuel occurs at the anode, and a reduction of oxygen occurs at the cathode.

The fuel is typically fed to the fuel cell via a pipe system from a tank in which the gaseous fuel is stored at high pressure. An isolation valve or shutoff valve is typically provided between the tank and a high-pressure portion of the pipe system. The high-pressure portion is also typically connected to a line portion connected to the fuel cell via a pressure regulator or flow control device.

Leaks can occur, particularly in the high-pressure portion of the pipe system, e.g., due to leaking valves or damage to the pipe system. To minimize a release of gaseous fuel into the environment, it is desirable to detect such leaks as quickly and reliably as possible.

U.S. Pat. No. 7,127,937 B2 discloses a method for detecting leaks in a fuel cell system, wherein upon shutdown of a fuel cell, a first and a second isolation valve are closed to disconnect a supply line from a fuel tank through the first isolation valve and from the fuel cell through the second isolation valve. After closing the valves, the pressure in the supply line is captured and stored. Before restarting the fuel cell, with the isolation valves closed, the pressure in the supply line is captured again and compared to the stored value to determine if a leakage is present based on a pressure difference.

### SUMMARY

Against this background, the present invention provides a method for monitoring a gas tank system and a fuel cell system.

According to a first aspect of the invention, the method for monitoring a gas system comprises determining a fuel mass flow rate requirement of a consumer system, e.g., one or a plurality of fuel cell systems, closing a first valve device in order to interrupt a gas feed from a tank into a high-pressure pipe system connecting the tank to the consumer system, capturing a pressure curve in the high-pressure pipe system while the first valve device is closed, in particular by means of a pressure sensor, determining a theoretical actual mass flow rate in the high-pressure pipe system on the basis of the captured pressure curve, comparing the theoretical actual mass flow rate in the high-pressure pipe system with the determined fuel mass flow rate requirement of the consumer system, and generating an error signal by means of a control device if the theoretical actual mass flow rate deviates from the fuel mass flow rate requirement by more than a threshold value.

According to a second aspect of the invention, a fuel cell system, which may be provided for use in a vehicle, for example, comprises a consumer system having a fuel cell assembly and a gas tank system having a tank for storing gas, in particular hydrogen, a high-pressure pipe system connected to the consumer system, a first valve device which is switchable between an open state, in which it connects the tank to the high-pressure pipe system, and a closed state, in which it separates the tank from the high-pressure pipe system, a pressure sensor for capturing a pressure in the high-pressure pipe system, and a control device which is connected in a signal-conducting manner to the first valve device, the pressure sensor, and the consumer system and configured to cause the fuel cell system to perform a method according to the first aspect of the invention.

One underlying idea of the invention is to close a first valve device or an isolation valve device arranged between the tank and the high-pressure pipe system when a known mass flow rate is to be supplied from the high-pressure pipe system to the consumer system, and to capture the pressure curve that develops after closing to determine a theoretical actual mass flow rate from it. For example, a pressure curve can be calculated from the pressure curve and, with the aid of the ideal gas equation and a mass balance of the high-pressure pipe system, a theoretical mass flow rate that leaves the high-pressure pipe system. If this theoretical mass flow rate is compared to the known mass flow rate requirement of the consumer system, the presence of a leak can be inferred, e.g., if the theoretical mass flow rate deviates from the mass flow rate requirement by more than a threshold value, either above or below.

An advantage of the invention is that the leak check can be carried out in virtually any state of the system, especially during operation. As the high-pressure pipe system has a certain volume and thus contains a certain volume of gas, even with a brief interruption of the fuel supply from the tank when the first valve device is closed, operation of the consumer system can be maintained. The leak check can thus be carried out quickly and easily so that leaks are reliably detected, especially during operation.

The features and advantages in connection with one aspect of the invention are also in each case disclosed for other aspects of the invention. In particular, the control device can initiate all method steps and perform various steps itself, such as steps for determining values based on measured physical variables. For example, the control device may comprise a computing unit, such as a CPU, an ASIC, an FPGA, or the like, and a data store, particularly a non-volatile data store such as a flash memory, an SD memory, or the like, that is readable by the computing unit. The data store may store software executable by the computing unit to cause the system to perform the steps of the method.

Advantageous embodiments and developments emerge from the further dependent claims and from the description with reference to the figures of the drawing.

According to some embodiments, it may be provided that generating the error signal by the control device may include generating a first error signal indicating the presence of a leak in the first valve device when the theoretical actual mass flow rate is less than the fuel mass flow rate requirement by more than the threshold value. For example, the computing unit of the control device may write a first error entry in the data store with information indicating that a leak in the first valve device is suspected. Inferring a leak in the first valve device when the theoretical actual mass flow rate is less than the fuel mass flow rate requirement is possible because, in this case, gas from the tank is still being supplied to the high-pressure piping system despite the closed first valve device. Consequently, the captured pressure in the high-pressure pipe system will not drop as much as it would with a tightly closing first valve device, and the theoretical actual mass flow rate will decrease accordingly.

According to some embodiments, it may be provided that generating the first error signal comprises writing an entry into a data store (62) if the theoretical actual mass flow rate is less than the fuel mass flow rate requirement by more than a first threshold value, and outputting a warning signal and/or initiating an emergency operation mode by the control device (6) if the theoretical actual mass flow rate is less than the fuel mass flow rate requirement by more than a second threshold value. Thus, when a high leak mass flow rate from the tank through the first valve device into the high-pressure piping system is determined, e.g., by calculating the difference between the theoretical actual mass flow rate and mass flow rate requirement, the control device may output a warning signal, e.g., in the form of a visual and/or audible signal. Optionally, an emergency operating mode of the consumer system may also be activated or another alternative response may be triggered by the error signal. In the event that only a small leak mass flow rate from the tank through the first valve device into the high-pressure piping system is determined, it may be sufficient to write a corresponding error entry into the data store of the control device.

According to some embodiments, it may be provided that generating the error signal by the control device comprises generating a second error signal indicating the presence of a leak in the high-pressure pipe system or a medium-pressure pipe system connected to the high-pressure pipe system when the theoretical actual mass flow rate is greater than the fuel mass flow rate requirement by more than the threshold value. If the theoretical actual mass flow rate is greater than the fuel mass flow rate requirement, i.e., if more fuel is discharged from the high-pressure pipe system when the first valve device is closed than the consumer system is known to need, the captured pressure in the high-pressure pipe system decreases faster than expected. From this, it can be inferred that the gas escapes from the high-pressure pipe system via other paths in the form of a leak mass flow rate.

According to some embodiments, it may be provided that generating the second error signal comprises writing an entry into a data store and/or outputting a warning signal and/or initiating an emergency operation if the theoretical actual mass flow rate exceeds the fuel mass flow rate requirement by more than a first threshold value, and initiating a safe operating state, e.g., by closing the first valve devices, if the theoretical actual mass flow is greater than the fuel mass flow rate requirement by more than a second threshold value. If the leakage mass flow rate is large, the control device can, for example, switch at least the first valve device to its closed state. If only a smaller leakage mass flow rate escapes, an error may be written to the data store of the control device.

According to some embodiments, the method may further comprise capturing a pressure in a medium-pressure pipe system of the consumer system, which is connected to the high-pressure pipe system via a flow control device, wherein generating the error signal by the control device includes generating a third error signal indicating the presence of a leak in the flow control device if the theoretical actual mass flow rate is greater than the fuel mass flow rate requirement by more than the threshold value and the pressure captured in the medium-pressure pipe system is greater than a medium-pressure threshold value. In particular, a pressure relief valve may be provided in the medium-pressure pipe system that opens upon reaching a predetermined pressure to release gas from the medium-pressure pipe system to the environment. If the theoretical actual mass flow rate is greater than the fuel mass flow rate requirement, i.e., if more fuel is discharged from the high-pressure pipe system when the first valve device is closed than the consumer system is known to need, the captured pressure in the high-pressure pipe system decreases faster than expected. From this, it can be inferred that the gas escapes from the high-pressure pipe system via other paths in the form of a leak mass flow rate. If it is further known that high pressure exists in the medium-pressure pipe system, e.g., pressure above a limit value, there is a possibility that the pressure relief valve may open when a certain amount of gas flows from the high-pressure system into it. In that case, an increased mass flow rate through the second valve device may be inferred due to a leakage connecting the high-pressure pipe system to the middle-pressure system.

According to some embodiments, it may be provided that determining the fuel mass flow rate requirement of the consumer system comprises determining an electrical voltage of the fuel cell assembly and calculating the fuel mass flow rate requirement on the basis of the electrical voltage, e.g., using a computational model linking the electrical voltage to the fuel mass flow rate. For example, the computing model may have been determined empirically, wherein the fuel mass flow rate is correlated to the electric voltage and optionally further physical variables, such as the temperature of the fuel cell. The computing model may be present as a functional context and/or in the form of a characteristic map. The determination of the fuel mass flow rate requirement may also be made in other ways, e.g. via control parameters of a dosing valve associated with a fuel inlet of the consumer system.

According to some embodiments, it may be provided that the gas tank system comprises a flow control device that is switchable between an open state and a closed state for connecting the high-pressure pipe system to the consumer system. For example, in the event that the theoretical actual mass flow rate is greater than the first upper threshold value, the control device may also switch the flow control device to the closed state. In the case that the theoretical actual mass flow rate is less than the fuel mass flow rate requirement, i.e. in the case where a leakage or leak is present in the first valve device, the second valve device may optionally be switched to the closed position or actuated such that the flow rate through the second valve device is reduced.

The flow control device may be generally configured to vary a flow rate and thus a mass flow rate from the high-pressure pipe system into the consumer system. Analogously, the pressure at which the gas flows from the high-pressure pipe system into the consumer system can also be varied by the flow control device. Thus, the flow control device may also be referred to as a pressure regulator. The flow control device can optionally include a second valve device, e.g., in the form of a switchable solenoid valve, which can be switched between the open state and the closed state.

According to some embodiments, it may be provided that the first valve device may include a switchable solenoid valve that can be switched between the open state and the closed state.

According to some embodiments, it may be provided that the high-pressure pipe system may include a supply connection for connecting a fueling system, wherein the supply connection is closed by a check valve to prevent gas escaping from the high-pressure pipe system.

### BRIEF DESCRIPTION OF THE DRAWINGS

The invention is explained below with reference to the figures of the drawings. The drawings show:

FIG. 1 a schematic illustration of a hydraulic diagram of a fuel cell system according to an exemplary embodiment of the invention; and

FIG. 2 a flowchart of a process according to an exemplary embodiment of the invention.

### DETAILED DESCRIPTION

In the drawings, identical reference numerals denote identical or functionally identical components, unless stated otherwise.

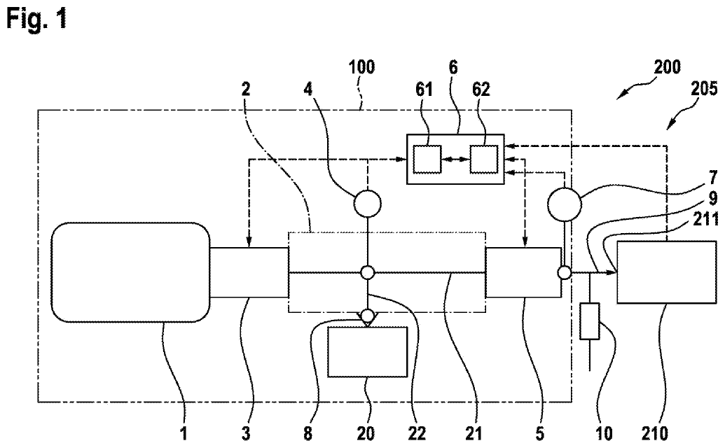

FIG. 1 schematically illustrates a fuel cell system 200 that may be used, for example, in a vehicle. The fuel cell system 200 includes a gas tank system 100 and a consumer system 205.

As shown only schematically in FIG. 1, the consumer system 205 includes a fuel cell assembly 210. The fuel cell assembly 210 comprises at least one fuel cell, but preferably multiple fuel cells connected electrically in series, configured to directly convert chemical energy stored in a gaseous fuel, such as hydrogen, together with oxygen into electrical energy. As further shown schematically in FIG. 1, the fuel cell assembly 210 includes a fuel supply connection 211 through which gaseous fuel can be supplied to the fuel cell assembly 210, particularly to an anode of the at least one fuel cell.

The gas tank system 100 will be explained below, by way of example, with reference to the fuel cell system 200. However, the invention is not limited to this. The gas tank system 100 and associated methods M may also be used in combination with other consumer systems, such as gas engines or similar devices.

As shown schematically in FIG. 1, the gas tank system 100 comprises a tank 1, a high-pressure pipe system 2, a first valve device 3, a pressure regulator or flow control device 5, a first pressure sensor 4, an optional second pressure sensor 7, and a control device 6. Optionally, the gas tank system 100 may further include a fueling connection or supply connection 20.

The tank 1 is designed to store gas, in particular hydrogen. For example, tank 1 may be designed to store gas at a pressure of up to 800 bar.

In particular, the high-pressure pipe system 2 may have a connection line 21 and optionally a supply line 22, as shown schematically and purely as an example in FIG. 1. The connection line 21 connects the tank 1 to the consumer system 205.

For example, the first valve device 3 may comprise a switchable solenoid valve 3 that can be switched between a closed state and an open state. Generally, the first valve device 3 can be switched between a closed state and an open state. As shown schematically in FIG. 1, the valve device 3 is arranged between the tank 1 and the high-pressure pipe system 2, in particular between the tank 1 and the connection line 21. In the open state, the first valve device 3 connects the tank 1 to the high-pressure pipe system 2. In the closed state, the first valve device 3 separates tank 1 and the high-pressure pipe system 2 from each other.

The flow control device 5 is also switchable between a closed state and an open state. For example, the flow control device 5 may include a switchable solenoid valve as a second valve device that is switchable between a closed state and an open state. Generally, the flow control device 5 may be configured to vary a gas flow rate or mass flow rate and/or a pressure of the gas. As shown schematically in FIG. 1, the flow control device 5 is arranged between the consumer system 205 and high-pressure pipe system 2, in particular between the consumer system 205 and connection line 21. In the open state, the flow control device 5 connects the consumer system 205 to the high-pressure pipe system 2. In the closed state, the flow control device 5 separates the consumer system 205 and the high-pressure pipe system 2 from each other.

The supply line 22 is connected to the supply connection 20, which can be configured as a plug-in connection for a tank nozzle. As shown in FIG. 1, a check valve 8 may be arranged in the supply line 22 that closes the supply connection 20 to prevent gas escaping from the high-pressure pipe system 2.

The high-pressure pipe system 2 forms a receiving volume for gas so that an amount of gas stored in it can be extracted from the high-pressure pipe system 2 when the first valve device 3 is closed. If gas is withdrawn from the high-pressure pipe system 2 with the first valve device 3 closed, e.g., by the consumer system 210 via the flow control device 5, the pressure in the high-pressure pipe system 2 decreases.

As shown in FIG. 1, the first pressure sensor 4 is connected to the high-pressure pipe system 2 and is configured to capture a pressure in the high-pressure pipe system 2. The optional second pressure sensor 7 is connected to a medium-pressure pipe system 9 which connects the flow control device 5 to the fuel supply connection 211 of the fuel cell assembly 210. The second pressure sensor 7 is thus configured to capture the pressure in the medium-pressure pipe system 9. As further shown schematically in FIG. 1, a pressure relief valve 10 may be provided in the medium-pressure pipe system 9 that opens to release gas into the environment when the pressure in the medium-pressure pipe system 9 exceeds a limit value.

The control device 6 is shown only schematically as a block in FIG. 1 and is realized as an electronic control device 6. As shown in FIG. 1 as an example, the control device 6 may comprise a computing unit 61, such as a CPU, an ASIC, an FPGA, or the like, and a data store 62, particularly a non-volatile data store such as a flash memory, an SD memory, or the like, that is readable by the computing unit. As shown schematically in FIG. 1, the control device 6 is connected in a signal-conducting manner to the first and second valve devices 3, 5, to the pressure sensor 4, 7, and to the consumer system 205, in particular to the fuel cell assembly 210. For example, the connection in a signal-conducting manner may be realized via a wired connection, e.g., via a field bus system, or via a wireless connection, e.g., via WiFi or the like.

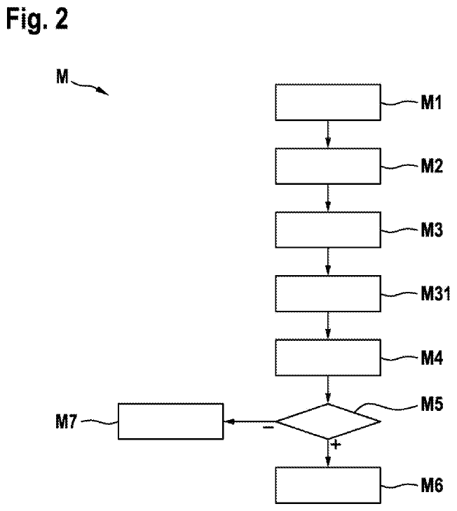

The control device 6 is configured to cause the fuel cell system 200 to perform the method M shown in FIG. 2. For example, the data store 62 may store software executable by the computing unit 61 to cause the system 200 to perform the method M.

In a first step M1, the control device 6 determines a fuel mass flow rate requirement of the consumer system 205. For example, the control device 6 may receive an electrical voltage currently generated by the fuel cell assembly 210 as an input variable and calculate the fuel mass flow rate requirement of the consumer system 205 based thereon, e.g., using a computing model stored in the data store 62, which may include, for example, an empirically determined characteristic map or empirically determined calculation function. In principle, other options for determining the fuel mass flow rate requirement are also contemplated. During step M1, the consumer system 205 is preferably supplied with a mass flow rate greater than zero from the tank 1. However, the invention is not limited to this, but may also be performed when the mass flow rate requirement of the consumer system 205 is equal to zero.

In step M2, the first valve device 3 is closed to interrupt a gas feed from the tank 1 into a high-pressure pipe system 2. For example, the control device 6 may output a control signal to the first valve device 3 to switch it to its closed state.

In step M3, a pressure curve in the high-pressure pipe system 2 is captured or recorded with the first valve device 3 closed by means of the first pressure sensor 4, e.g. over a pre-determined period of time, which can e.g. be between 0.5 seconds and 5 seconds.

In the optional step M31, a pressure in the middle-pressure pipe system 9 is captured by means of the second pressure sensor 7, in particular while the first valve device 3 is closed.

In step M4, the control device 6 determines a theoretical actual mass flow rate in the high-pressure pipe system 2 based on the captured pressure curve. For example, the control device 6 may calculate a pressure gradient from the pressure curve and use the ideal gas equation and a mass balance over the high-pressure pipe system 2 to calculate the theoretical mass flow rate discharged from the high-pressure pipe system 2, assuming that no leakage flows occur.

In step M5, the control device 6 compares the calculated theoretical actual mass flow rate with the determined fuel mass flow rate requirement of the consumer system 205. In a tight high-pressure pipe system 2 in which no appreciable leakage flows occur, the theoretical actual mass flow rate would match the determined fuel mass flow rate requirement, apart from measurement and calculation inaccuracies. If the theoretical actual mass flow rate deviates from the fuel mass flow rate requirement by more than a threshold value, as shown in FIG. 2 by the symbol “+”, the method proceeds to step M6. The threshold value may in particular take into account the aforementioned measurement and calculation inaccuracies. If the theoretical actual mass flow rate deviates from the fuel mass flow rate requirement by less than the threshold value, as shown in FIG. 2 by the symbol “−”, i.e., if no significant leakage flows occur, the method proceeds to step M7. Optionally, in step M5, a comparison of the pressure captured in step M31 in the medium-pressure line system 9 with a medium-pressure threshold is also made.

In step M5, a difference between the theoretical actual mass flow rate and the mass flow rate requirement may be calculated. This difference or the amount of the difference can then be compared to the threshold value to check whether the amount of the difference exceeds the threshold value. If the theoretical actual mass flow rate is less than the fuel mass flow rate requirement by more than the threshold value, it can be concluded that there is a leak or a leakage in the first valve device 3, as in this case gas also flows from the tank 1 into the high-pressure pipe system 2 when the first valve device 3 is in the closed state. Thus, with constant actual mass flow rate discharge through the consumer system 205, the pressure gradient with valve 3 closed is less than it would be if valve 3 were to close tightly. Conversely, it can be concluded that there is a leak in the high-pressure pipe system 2, with more gas escaping from the high-pressure pipe system 2 than expected, if the theoretical actual mass flow rate is greater than the fuel mass flow rate requirement by more than the threshold value.

In step M7, the control device 6 can switch the first valve device 2 back to the open position.

In step M6, however, in the case that a leak mass flow rate is present, the control device 6 generates an error signal. The error signal can generally be output, e.g., as a warning signal and/or the error signal can generate an error entry in the data store 62. It is also conceivable that the error signal causes the output of a control signal by the control device 6, e.g., to actuate the first valve device 3 and/or the flow control device 5.

For example, generating the error signal in step M6 may include generating a first error signal indicating the presence of a leak in the first valve device 3 when the theoretical actual mass flow rate is less than the fuel mass flow rate requirement by more than the threshold value, as explained above. In this case, in step M6, the control device 6 may output a warning signal, e.g., in the form of an acoustic and/or visual signal, if the theoretical actual mass flow rate is less than a lower threshold value or if the theoretical actual mass flow rate is less than the fuel mass flow rate requirement by more than a second threshold value. Alternatively or additionally, in this case, an emergency operation mode of the consumer system 205 may be activated by the control device 6, e.g., by outputting the error signal as a control signal to the fuel cell assembly 205 to deactivate it. If the theoretical actual mass flow rate is greater than a further lower threshold value and less than the aforementioned lower threshold value, or if the theoretical actual mass flow rate is less than the fuel mass flow rate requirement by more than a first threshold value, the computing unit 61 can, for example, write an entry into the data store 62 with the second error signal, in particular with the content that a leak is present in the first valve device 3.

Alternatively or additionally, in step M6, the control device 6 may generate a second error signal indicating the presence of a leak in the high-pressure pipe system 2 or medium-pressure pipe system 9 when the theoretical actual mass flow rate is greater than the fuel mass flow rate requirement by more than the threshold value. In particular, generating the second error signal may include outputting a control signal by the control device 6 to lock fuel withdrawal from tank 1 and/or high-pressure pipe system 2. In particular, if the theoretical actual mass flow rate is greater than a first upper threshold value or if the theoretical actual mass flow rate is greater than the fuel mass flow rate requirement by more than a second threshold value, a safe operating state may be initiated. In this case, a high leakage mass flow rate is assumed and the control device 6 can, for example, switch the first valve device 3 and optionally also the flow control device 5 to the closed state. If the theoretical actual mass flow rate is greater than a further upper threshold value and less than the previously mentioned upper threshold value, or if the theoretical actual mass flow rate is greater than the fuel mass flow rate requirement by more than a first threshold value, this corresponds to a case in which there is only a smaller leak mass flow rate. In that case, the computing unit 61 may write a corresponding entry into a data store 62 using the second error signal, for example, with the content indicating the presence of a leak in the high-pressure pipe system 2, and/or output a warning signal and/or initiate an emergency operation.

Furthermore, generating M6 the error signal may also include generating a third error signal indicating the presence of a leak in the flow control device 5 when the theoretical actual mass flow rate is greater than the fuel mass flow rate requirement by more than the threshold value, and when it is determined in step M5 that the pressure captured in M31 in the medium-pressure pipe system 9 is greater than the medium-pressure threshold value. In this case, it can be expected that the flow control device 5 will allow more mass flow than would be expected at the respective degree of opening of the second valve device 5, and subsequently, the pressure relief valve 10 opens due to the high pressure in the medium-pressure pipe system 9.

Although the present invention has been explained hereinabove by way of example with reference to exemplary embodiments, it is not limited thereto and can be modified in many ways. Combinations of the above exemplary embodiments are in particular also conceivable.

1. A method (M) for monitoring a gas tank system (100), comprising:
determining (M1), via a control device (6), a fuel mass flow rate requirement of a consumer system (205);
closing (M2), via the control device (6), a first valve device (3) to interrupt a gas feed from a tank (1) into a high-pressure pipe system (2) connecting the tank (1) to the consumer system (205);
capturing (M3), via the control device (6), a pressure curve in the high-pressure pipe system (2) while the first valve device (3) is closed;
determining (M4), via the control device (6), a theoretical actual mass flow rate in the high-pressure pipe system (2) based on the captured pressure curve;
comparing (M5), via the control device (6), the theoretical actual mass flow rate in the high-pressure pipe system (2) with the determined fuel mass flow rate requirement of the consumer system (205); and
generating (M6) an error signal via the control device (6) when the theoretical actual mass flow rate deviates from the fuel mass flow rate requirement by more than a threshold value.

2. The method (M) according to claim 1, wherein generating (M6) the error signal by the control device (6) comprises generating a first error signal indicating the presence of a leak in the first valve device (3) when the theoretical actual mass flow rate is less than the fuel mass flow rate requirement by more than the threshold value.

3. The method (M) according to claim 2, wherein generating the first error signal comprises writing an entry into a data store (62) if the theoretical actual mass flow rate is less than the fuel mass flow rate requirement by more than a first threshold value, and outputting a warning signal and/or initiating an emergency operation mode by the control device (6) if the theoretical actual mass flow rate is less than the fuel mass flow rate requirement by more than a second threshold value.

4. The method (M) according to claim 1, wherein generating (M6) the error signal by the control device (6) comprises generating a second error signal indicating the presence of a leak in the high-pressure pipe system (2) or a medium-pressure pipe system (9) connected to the high-pressure pipe system (2) when the theoretical actual mass flow rate is greater than the fuel mass flow rate requirement by more than the threshold value.

5. The method (M) according to claim 4, wherein generating the second error signal comprises writing an entry into a data store (62) and/or outputting a warning signal and/or initiating an emergency operation mode when the theoretical actual mass flow rate is greater than the fuel mass flow rate requirement by more than a first threshold value, and initiating a safe operating state when the theoretical actual mass flow rate is greater than the fuel mass flow rate requirement by more than a second threshold value.

6. The method (M) according to claim 1, additionally comprising:
capturing (M31) a pressure in a medium-pressure pipe system (9) of the consumer system (205), which is connected to the high-pressure pipe system (2) via a flow control device (5);
wherein generating (M6) the error signal by the control device (6) comprises generating a third error signal indicating the presence of a leak of the flow control device (5) when the theoretical actual mass flow rate is greater than the fuel mass flow rate requirement by more than the threshold value and the pressure captured in the medium-pressure pipe system (9) is greater than a medium-pressure threshold value.

7. A fuel cell system (200) comprising:
a consumer system (205) with a fuel cell assembly (210);
a gas tank system (100) with a tank (1) for storing gas, a high-pressure pipe system (2) connected to the consumer system (205), a first valve device (3), which is switchable between an open state, in which it connects the tank (1) to the high-pressure pipe system (2), and a closed state, in which it separates the tank (1) from the high-pressure pipe system (2), a pressure sensor (4) for capturing a pressure in the high-pressure pipe system (2) and a control device (6), which is connected to the first valve device (3), the pressure sensor (4), and the consumer system (205) in a signal-conducting manner and is configured to cause the fuel cell system (200) to
determine (M1) a fuel mass flow rate requirement of a consumer system (205);
close (M2) a first valve device (3) to interrupt a gas feed from a tank (1) into a high-pressure pipe system (2) connecting the tank (1) to the consumer system (205);
capture (M3) a pressure curve in the high-pressure pipe system (2) while the first valve device (3) is closed;
determine (M4) a theoretical actual mass flow rate in the high-pressure pipe system (2) based on the captured pressure curve;
compare (M5) the theoretical actual mass flow rate in the high-pressure pipe system (2) with the determined fuel mass flow rate requirement of the consumer system (205); and
generate (M6) an error signal when the theoretical actual mass flow rate deviates from the fuel mass flow rate requirement by more than a threshold value.

8. The fuel cell system (200) according to claim 7, wherein the gas tank system (100) comprises a flow control device (5) which is switchable between an open state and a closed state for connecting the high-pressure pipe system (2) to the consumer system (205).

9. A fuel cell system (200) according to claim 7, wherein the first valve device (3) comprises a switchable solenoid valve that is switchable between the open state and the closed state.
